(19) United States
(12) Patent Application Publication
(10) Pub. No.: US 2005/0043132 A1
(43) Pub. Date: Feb. 24, 2005

(54) Chain pulley block

(76) Inventors: Oliver Moll, Solingen (DE); Jurgen Heun, Dortmund (DE); Ralf Eising, Herne (DE); Udo Gersemsky, Herdecke (DE); Bernhard Norpoth, Wetter (DE); Erik Appel, Wetter (DE); Klaus Wissing, Pleisweiler-Oberhofen (DE); Torsten Sattler, Sprockhovel (DE); Hansjurgen Linde, Coburg (DE); Thilo Walloshek, Gevelsberg (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/909,660

(22) Filed: Aug. 2, 2004

(30) Foreign Application Priority Data
Aug. 1, 2003 (DE) 103 35 984.2

(51) Int. Cl. F16H 9/02; F16H 63/00; B62J 13/00

(52) U.S. Cl. 474/144; 474/70

(57) ABSTRACT

The invention concerns a chain pulley block with a chain wheel for positive-locking transmission of the lift force to the chain and a chain guide arranged in the region of the chain wheel, for guiding the chain, especially a round-link chain, on the chain wheel. In order to make it fast, easy and inexpensive to replace wearing parts, such as chain (3), chain wheel (4) and chain guide (2), it is proposed that the chain guide (2), the chain wheel (4) and the chain (3) be assembled into a structural unit (1), which is removably fastened to the chain pulley block (7).

### BACKGROUND OF THE INVENTION

The invention concerns a chain pulley block with a chain wheel for positive-locking transmission of the lifting force to the chain and a chain guide arranged in the region of the chain wheel for guiding of the chain, especially a round-link chain, on the chain wheel.

Chain pulley blocks of the kind described above are known, for example, from German Patent DE 198 49 693. These chain pulley blocks have a chain guide for undisturbed running of the chain about the chain wheel, making sure that the chain links do not get caught or jammed. In order to reduce the wear on the chain, it is lubricated over its entire length.

The chain, the chain guide and also the chain wheel, however, are subject to natural wear which, depending on the intensity of use of the chain pulley block and the size of the loads being handled, makes necessary a replacement of the worn chain, chain guide, and also chain wheel from time to time. Also, due to lengthening of the chain links because of permanent material expansion over time, the positive-locking movement of the chain about the chain wheel can become disturbed, so that the chain wheel is more intensively worn. Therefore, as part of regular maintenance intervals, all wearing parts are inspected and replaced if necessary. For known chain pulley blocks, the replacement of, for example, the chain and the chain wheel means a considerable expense, since after taking down the chain pulley block from its suspension one has to disassemble the motor and other small parts in order to get at the wearing parts. This work is very time-intense and costly. The availability of the chain pulley block will be affected by it. The maintenance costs are high because of the required labor time. The mounting of the chain pulley block during its fabrication in the factory is equally expensive: in this case, the production costs are very high.

### SUMMARY OF THE INVENTION

The task of the present invention is to create a chain pulley block that enables a replacement of wearing parts such as chain, chain wheel, and chain guide in a fast, simple and inexpensive manner.

This task is achieved with a chain pulley block according to the features of claim 1 of the present invention. Advantageous configurations of the invention are given in subsidiary claims 2 through 11.

According to the invention, in a chain pulley block with a chain wheel for positive-locking transmission of the lift force to the chain and a chain guide arranged in the region of the chain wheel to guide the chain, especially a round-link chain, on the chain wheel, due to the fact that the chain guide, the chain wheel, and the chain are assembled in a single structural unit, removably fastened to the chain pulley block, the assembly and also the disassembly of the structural parts belonging to the structural unit designated as a chain set is facilitated. There is no need to disassemble individual parts of the chain set, or to take down the complete pulley block. Instead, the structural unit is mounted and dismounted as a whole. A worn structural unit will only be replaced by a new prefabricated structural unit. The making of a set according to the invention and the handling of the wearing parts as a structural unit considerably simplify the assembly and disassembly and help save costs, both during fabrication and during maintenance and repair work. Also, the chain wheel, chain guide and chain are matched up with each other so that they wear uniformly and thus need to be replaced at roughly the same time.

In a disclosed embodiment, the chain guide is mounted floating on the chain wheel and the chain engaging with the chain wheel. Rejecting the usual screw fastening of the chain guide to the housing of the chain pulley block, the floating fastening on the chain wheel and the chain allows a favorable orienting of the chain guide to the chain wheel and the chain, so that the wearing behavior is promoted. Constraints from the chain drive are no longer transmitted to the housing, but rather intercepted within the chain guide.

The chain guide may be fastened to be floating on the chain pulley block, according to another feature of the invention, it becomes possible to shape the chain guide from a wear-resistant plastic material, i.e., to use a light economical plastic for the first time in this load application.

In a further embodiment, the chain guide is prevented from twisting in the circumferential direction of the chain wheel relative to the chain pulley block, especially its gearbox casing. This will not cancel out the floating mounting of the chain guide in itself.

In a disclosed embodiment, the chain wheel be axially secured on an output shaft of a gearing of the chain pulley block by means of a securing ring, and thus the structural unit is connected to the chain pulley block. Hence, by simple loosening of the chain wheel, it is possible to pull the chain set as a whole unit off from the driven shaft of the gearing and replace it with a prefabricated set of these parts. All that needs be done is to first loosen the disentangling plate from the housing of the chain pulley block. Screw fasteners between the chain guide itself and the housing of the chain pulley block are eliminated.

In order to be able to remove the structural unit from the chain pulley block as a unit, preferably without dismantling the drive motor, an installation space is present inside the chain pulley block adjacent to the end of the output shaft and, thus, the installed chain set, of such dimension that the complete structural unit can be pulled off from the output shaft and then be pulled out sideways from the chain pulley block.

In order to further improve the comfort in the assembly and disassembly of the chain set, at least the installation space and the installed structural unit can be opened and closed with a cover, and the cover is removably fastened to the chain pulley block. Thus, after merely opening the cover, the installation space is already accessible for the assembly or disassembly of the chain set.

In a disclosed embodiment, the structural unit is further supplemented with a disentangling plate with boreholes for the passage of the load strand and the empty strand of the chain and end pieces at the ends of the chain. The structural unit may further include at least one buffer on the chain and can be added to the chain set in the region of the end piece and the hook tackle being secured to the chain.

In a structurally simple embodiment, the chain guide is formed by a lengthwise divided housing, in which the chain and the chain wheel are also accommodated.

A sample embodiment of the invention is shown in the drawings and shall be described hereafter.

### BRIEF DESCRIPTION OF THE DRAWINGS

FIG. 1 is the replaceable structural unit, or chain set, according to the invention, in the assembled condition,

FIG. 2 is a side elevation of a chain pulley block of the invention with a portion of the side removed to reveal the replaceable structural unit, and

FIG. 3 is an enlarged representation of the replaceable structural unit of the invention.

### DESCRIPTION OF THE PREFERRED EMBODIMENT

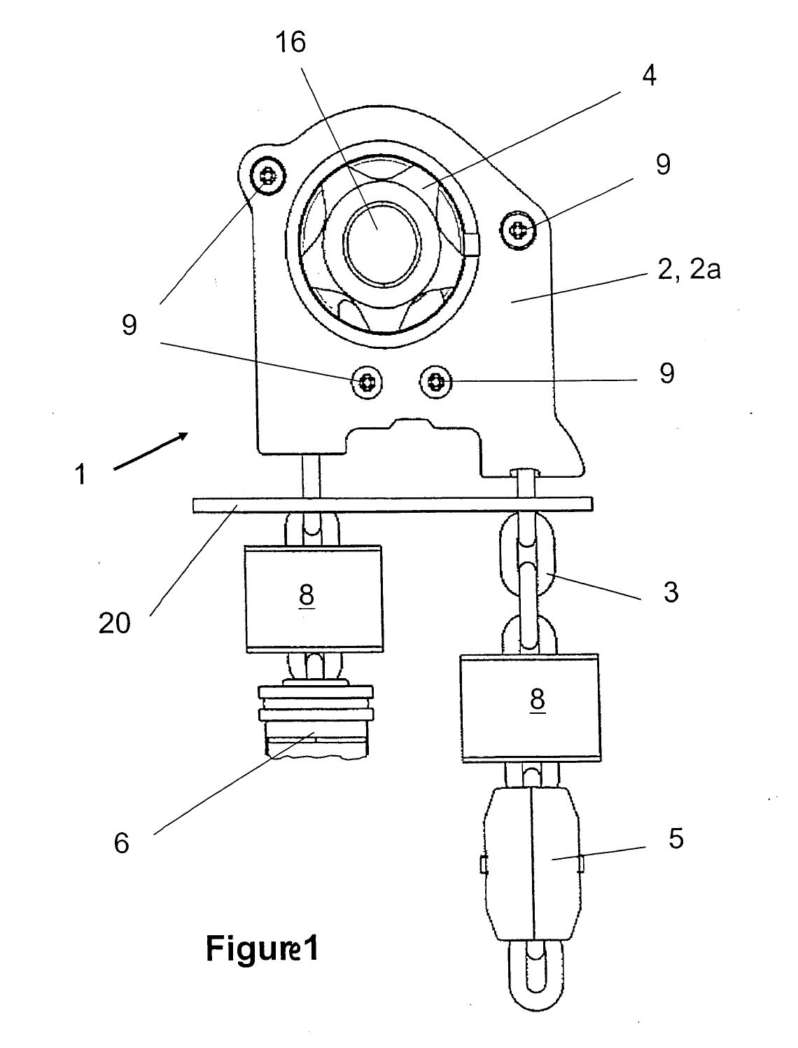

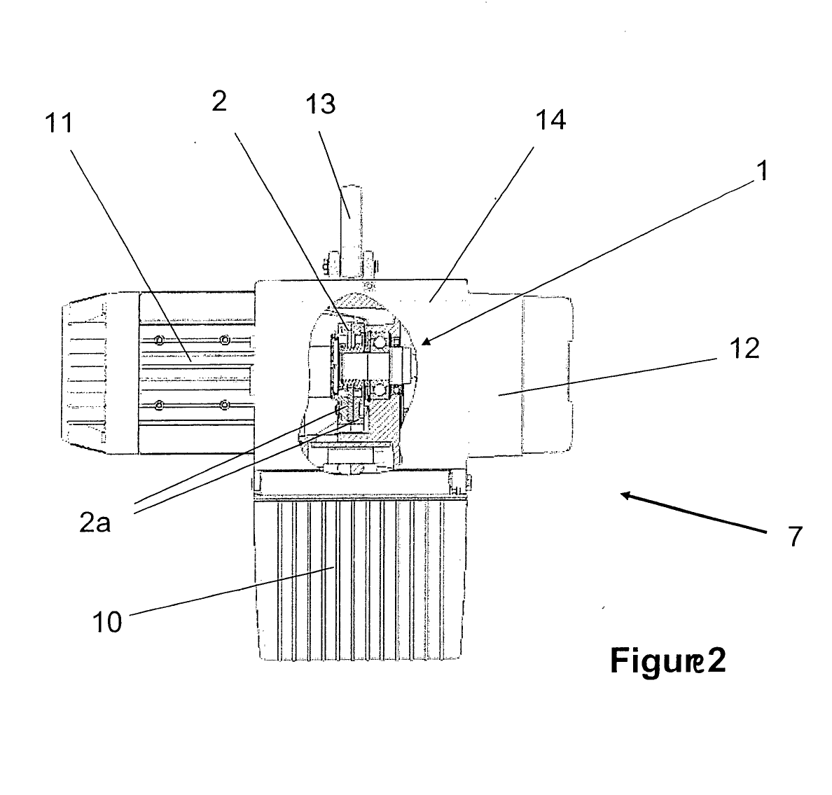

FIG. 1 shows in a simplified schematic view a replaceable structural unit 1 of the invention, designated as a chain set. There is a chain guide 2 for a chain 3, whose housing 2a encompasses and guides the chain 3, which is a round-link chain. A chain wheel 4 is arranged on an output shaft 16 of a transmission of the chain pulley block and the lift force of the chain pulley block 7 is transmitted in positive locking to the chain 3 by the link plates and grooves at the circumference of the chain wheel 4. At the right-hand end of the chain 3 in the drawing is fastened an end piece 5, which goes into the chain magazine 10 not shown here (see FIG. 2). The end piece 5 consists of two halves, which at least partly enclose several neighboring chain links in positive locking and are joined together removably or permanently. The types of fastening which can be used involve caulking or riveting. At the opposite end of the chain 3 is arranged a hook tackle 6. At this end of the chain 3 as well, an end piece 5 (not shown) is fastened, being enclosed in positive locking by the halves of the hook tackle 6. Buffers 8 are arranged on the chain 3 in the region of the hook tackle 6 and the end piece 5 or the two end pieces 5 at the side facing the chain guide 2. The chain guide 2 consists of a lengthwise divided housing 2a, made from plastic. The shell-shaped halves of the housing 2a are screwed together at 9. Before being screwed together, the chain wheel 4 and the chain 3 are inserted in one half of the housing 2a.

Furthermore, it can be noticed from FIG. 1 that a customary disentangling plate 20 of chain pulley blocks belongs to the structural unit 1, with corresponding but not represented boreholes for the passage of the load strand and the empty strand of the chain 3. This disentangling plate 20 has the task of guiding the load strand and the empty strand of the chain 3 as they move in or out of the chain wheel 4 and prevents them from getting caught. This disentangling plate 20 is screwed onto the housing 22 of the gearing 12 from below during the course of assembling the structural unit 1.

FIG. 2 shows the chain pulley block 7 as a whole. As can be noticed, it is suspended by means of the suspension 13 from a fixed point, not shown. A motor for the chain pulley block 7 is designated by 11, its gearing is indicated by 12, and its housing by 22. The chain magazine 10 is suspended beneath the chain pulley block 7, especially beneath the chain wheel 4, to take up the empty strand of the chain 3. The chain pulley block 7, especially the region of the chain set 1 and an adjoining installation space 21, is enclosed laterally by a cover 14. This cover 14 is removably connected to the chain pulley block 7 and can be taken off for assembly or disassembly of the structural unit. The cover 14 is depicted broken open at its front side, in order to show the installation position of the replaceable structural unit 1.

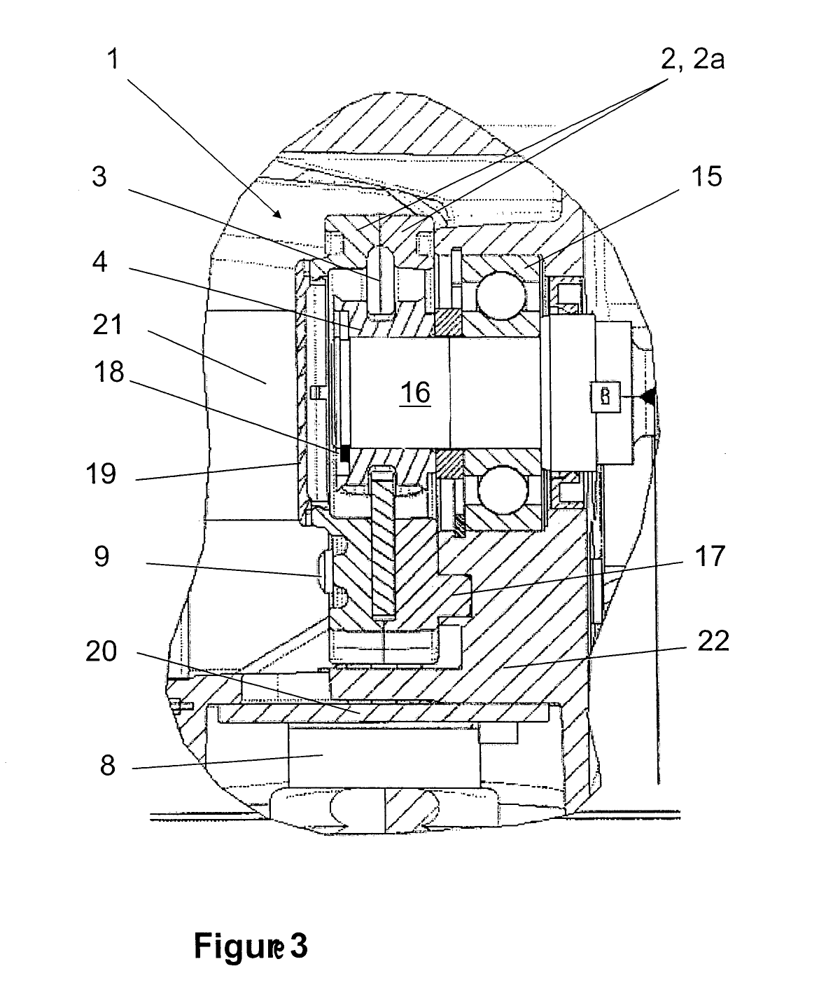

FIG. 3 shows a magnified feature of FIG. 2 from the region of the replaceable structural unit 1. The structural unit 1 consists essentially—as already described for FIG. 1—of the chain guide 2, the chain 3, the chain wheel 4, to which the hook tackle 6, the end pieces 5, the buffers 8 and the disentangling plate 20 can be added. For the installation, the structural unit 1, especially its chain guide 2 and the chain wheel 4 located therein and the corresponding segment of the chain 3, is pushed from the side into the open installation space 21 adjoining the driven shaft 16. In the region of the installation space 21, the housing 22 is slotted and thus open at the bottom, so that the load strand and the empty strand as well as the disentangling plate 20 can also be moved into their installation position. After this, the chain wheel 4, together with the chain guide 2 and the chain 3, is pushed onto the shaft 16 of the gearing 12 and secured on the shaft with a securing ring 18. A pin 17 arranged on the chain guide housing 2a engages with the housing of the chain pulley block 7 and secures the structural unit 1 against twisting on the shaft 16. One notices at 15 a ball bearing, by which the shaft 16 is mounted in the gearing case. The front end of the shaft 16 is closed by a cover 19, which is locked into an opening of the chain guide housing 2a.

In order to replace the chain 3 or the chain wheel 4 or another wearing part, one no longer opens and removes the housing 2a of the chain guide 2, but rather the entire structural unit 1—consisting of chain guide 2, the chain 3, the chain wheel 4, the hook tackle 5 and the end piece 6, the buffers 8 and the disentangling plate 20—after opening the cover 19, loosening the disentangling plate 20 and loosening the securing ring 18, is pulled off from the shaft 16 and replaced with another structural unit 1, which is pushed in reverse sequence onto the shaft 16 and locked there with the securing ring 18.

Changes and modifications in the specifically described embodiments can be carried out without departing from the principles of the invention which is intended to be limited only by the scope of the appended claims, as interpreted according to the principles of patent law including the doctrine of equivalents.

1. A chain pulley block, comprising:
a chain wheel for positive-locking transmission of the lift force to the chain and a chain guide arranged in the region of said chain wheel, for guiding the chain on said chain wheel; and
wherein said chain guide, said chain wheel and said chain are assembled into a structural unit, said structural unit being removably fastened to the chain pulley block.

2. The chain pulley block of claim 1, wherein said chain guide is mounted floating on said chain wheel and the chain engaging with said chain wheel.

3. The chain pulley block of claim 2, wherein said chain guide is prevented from twisting in the circumferential direction of said chain wheel relative to said chain pulley block.

4. The chain pulley block of claim 3, wherein said chain guide is made from a wear-resistant plastic material.

5. The chain pulley block of claim 4, wherein said chain wheel is axially secured by means of a securing ring on an output shaft of a gearing of said chain pulley block, wherein said structural unit is connected to said chain pulley block.

6. The chain pulley block of claim 5, including an installation space inside said chain pulley block, adjoining the end of said output shaft, of such dimension that said structural unit can be pulled off from said output shaft and then be pulled out sideways from said chain pulley block.

7. The chain pulley block of claim 6, wherein at least the installation space and said structural unit can be opened or closed with a cover and said cover is removably fastened to said chain pulley block.

8. The chain pulley block of claim 7, wherein said structural unit additionally has a disentangling plate with boreholes for the passage of the load strand and the empty strand of the chain, an end piece arranged at one end of the chain, and a hook tackle arranged at the other end of the chain.

9. The chain pulley block of claim 8, including at least one buffer that can be pushed onto the chain and secured in the region of said end piece and the hook tackle, and said at least one buffer is also a component of said structural unit.

10. The chain pulley block of claim 9, wherein said chain guide is formed by a housing in which the chain and said chain wheel are also accommodated.

11. The chain pulley block of claim 10, wherein said housing of the chain guide is lengthwise divided to accommodate the chain and said chain wheel.

12. The chain pulley block of claim 1, wherein said chain guide is prevented from twisting in the circumferential direction of said chain wheel relative to said chain pulley block.

13. The chain pulley block of claim 12, wherein said chain guide is made from a wear-resistant plastic material.

14. The chain pulley block of claim 13, wherein said chain wheel is axially secured by means of a securing ring on an output shaft of a gearing of said chain pulley block, wherein said structural unit is connected to said chain pulley block.

15. The chain pulley block of claim 14, including an installation space inside said chain pulley block, adjoining the end of said output shaft, of such dimension that said structural unit can be pulled off from said output shaft and then be pulled out sideways from said chain pulley block.

16. The chain pulley block of claim 15, wherein at least the installation space and said structural unit can be opened or closed with a cover and said cover is removably fastened to said chain pulley block.

17. The chain pulley block of claim 16, wherein said structural unit additionally has a disentangling plate with boreholes for the passage of the load strand and the empty strand of the chain, an end piece arranged at one end of the chain, and a hook tackle arranged at the other end of the chain.

18. The chain pulley block of claim 17, including at least one buffer that can be pushed onto the chain and secured in the region of said end piece and the hook tackle, and said at least one buffer is also a component of said structural unit.

19. The chain pulley block of claim 18, wherein said chain guide is formed by a housing in which the chain and said chain wheel are also accommodated.

20. The chain pulley block of claim 19, wherein said housing of the chain guide is lengthwise divided to accommodate the chain and said chain wheel.

21. The chain pulley block of claim 1, wherein said chain guide is made from a wear-resistant plastic material.

22. The chain pulley block of claim 1, wherein said chain wheel is axially secured by means of a securing ring on an output shaft of a gearing of said chain pulley block, wherein said structural unit is connected to said chain pulley block.

23. The chain pulley block of claim 22, including an installation space inside said chain pulley block, adjoining the end of said output shaft, of such dimension that said structural unit can be pulled off from said output shaft and then be pulled out sideways from said chain pulley block.

24. The chain pulley block of claim 23, wherein at least the installation space and said structural unit can be opened or closed with a cover and said cover is removably fastened to said chain pulley block.

25. The chain pulley block of claim 1, wherein said structural unit additionally has a disentangling plate with boreholes for the passage of the load strand and the empty strand of the chain, an end piece arranged at one end of the chain, and a hook tackle arranged at the other end of the chain.

26. The chain pulley block of claim 25, including at least one buffer that can be pushed onto the chain and secured in the region of said end piece and the hook tackle, and said at least one buffer is also a component of said structural unit.

27. The chain pulley block of claim 1, wherein said chain guide is formed by a housing in which the chain and said chain wheel are also accommodated.

28. The chain pulley block of claim 27, wherein said housing of the chain guide is lengthwise divided to accommodate the chain and said chain wheel.
